(19) United States
(12) Patent Application Publication
(10) Pub. No.: US 2011/0214167 A1
(43) Pub. Date: Sep. 1, 2011

(54) IMAGE PROCESSING APPARATUS, IMAGE PROCESSING SYSTEM, AND DISPLAY SCREEN CONTROLLING METHOD

(75) Inventor: Tetsuya OKA, Osaka-shi (JP)

(73) Assignee: Konica Minolta Business Technologies, Inc., Chiyoda-ku (JP)

(21) Appl. No.: 13/033,743

(22) Filed: Feb. 24, 2011

(30) Foreign Application Priority Data
Feb. 26, 2010 (JP) 2010-041874

(51) Int. Cl. G06F 21/20; G06F 21/00

(52) U.S. Cl. 726/7; 726/19

(57) ABSTRACT

An image processing apparatus comprises: a display part on which various information is displayed; an authentication information inputting part for receiving entry of authentication information made by a user; a setting information inputting part for receiving an operation to set made by the user, and inputting setting information; an authentication processing part for starting authentication processing to execute user authentication based on the authentication information in response to the entry of the authentication information; and a display controlling part for displaying an initial operation screen operable for the user to make setting on the display part in parallel with the authentication processing executed by the authentication processing part, and for reflecting the setting information received by the setting information inputting part before obtaining a result of the authentication processing to the initial operation screen. So, a waiting time of the user after the entry of the authentication information is reduced. Also, the user is allowed to start making operation relatively-early, and convenience of the image processing apparatus is enhanced.

This application is based on the application No. 2010-041874 filed in Japan, the contents of which are hereby incorporated by reference.

### BACKGROUND OF THE INVENTION

1. Field of the Invention

The present invention relates to an image processing apparatus, an image processing system, and a display screen controlling method.

2. Description of the Background Art

Image processing apparatus called as complex devices or MFPs (multi function peripherals) installed in places such as an office have several functions including a copy function, a print function, a scanner function, a fax function, and a box function (storage function), related to image processing, and is used by multiple users. In these days, the above-described image processing apparatus executes user authentication when used by a user intending to prevent from being used by unspecified users, and/or to restrict available functions for each user. When, for example, a user uses the image processing apparatus, he or she makes an operation to an operational panel of the image processing apparatus to enter information for authentication (hereafter, authentication information) such as user ID and password. If the entered authentication information matches user information registered in advance, the authentication results in success. As the result, restriction of function defined in advance for the user may be specified. The user is allowed to use the image processing apparatus within the restriction.

Recently, the plurality of image processing apparatuses has been installed in a network environment such as an office. Because of such circumstance, a server device executes user authentication is installed in the network, and all users who use each image processing apparatus are managed by the server device. The known technique is introduced for example in Japanese Patent Application Laid-Open No. JP2008-312123 A. By way of example, when using the image processing apparatus, the user holds his or her IC card over a card reader, thereby making entry of authentication information. The image processing apparatus then transmits the entered authentication information to the server device, and the server device executes user authentication. In response to completion of user authentication in the server device, its result is transmitted to the image processing apparatus as a result of authentication. After receiving the result of authentication, the image processing apparatus determines whether or not the user is authorized to use the image processing apparatus. When the user is authorized to use, the image processing apparatus executes a processing based on user's information for usage restriction. The image processing apparatus then transits to a logged-in state in which the user is logging in.

According to the above-described technique, however, even when authentication results in success, it takes time after transmission of the authentication information to the server device before the image processing apparatus executes the processing based on user's information for usage restriction. So, the user is not allowed to make any operation until the image processing apparatus transits to the logged-in state after entering the authentication information. The user needs to wait in front of the image processing apparatus with making no operation. This results in reduction of efficiency in operation or even in interference of convenience of the image processing apparatus for use.

### SUMMARY OF THE INVENTION

The present invention is intended to solve the problem described above. The present invention is intended to provide an image processing apparatus, an image processing system, and a display screen controlling method capable of reducing the time the user needs to wait and allowing the user to start making an operation relatively fast, thereby improving the convenience.

First, the present invention is directed to an image processing apparatus.

According to one aspect of the image processing apparatus, the image processing apparatus comprises: a display part on which various types of information is displayed; an authentication information inputting part for receiving entry of authentication information made by a user; a setting information inputting part for receiving an operation to set made by the user, and inputting setting information; an authentication processing part for starting authentication processing to execute user authentication based on the authentication information in response to the entry of the authentication information to the authentication information inputting part; and a display controlling part for displaying an initial operation screen operable for the user to make setting on the display part in parallel with the authentication processing, and for reflecting the setting information received by the setting information inputting part to the initial operation screen before a result of the authentication processing is obtained and displaying.

Second, the present invention is directed to an image processing system comprising a server device and an image processing apparatus being capable of making data communication with each other through a network.

According to one aspect of the image processing system, the server device includes: a storage part for storing user information in which information related to multiple users is registered; a receiving part for receiving authentication information transmitted from the image processing apparatus; a user authenticating part for executing user authentication by matching the authentication information received by the receiving part and the user information stored in the storage part; and a transmitting part for transmitting a result of the user authentication executed by the user authenticating part to the image processing apparatus. The image processing apparatus includes: a display part on which various types of information is displayed; an authentication information inputting part for receiving entry of the authentication information made by the user; a setting information inputting part for receiving an operation to set made by the user, and inputting setting information; an authentication processing part for sending a request for user authentication to the server device by transmitting the authentication information received by the authentication information inputting part to the server device; and a display controlling part for displaying an initial operation screen operable for the user to make setting on the display part at time of sending the request for user authentication to the server device, and for reflecting the setting information received by the setting information inputting part before receiving the result of user authentication from the server device to the initial operation screen and displaying.

Third, the present invention is directed to a display screen controlling method.

According to one aspect of the display screen controlling method, the display screen controlling method comprises the steps of: (a) displaying an authentication guiding screen prompting a user to make operation to enter authentication information on a predetermined display part; (b) receiving the entry of the authentication information made by the user with the authentication guiding screen being displayed; (c) starting authentication processing to execute user authentication based on the authentication information entered by the user; and (d) displaying an initial operation screen operable for the user to make setting on the display part in response to start of the authentication processing, and reflecting the setting information entered by the user before obtaining a result of the authentication processing to the initial operation screen.

### BRIEF DESCRIPTION OF THE DRAWINGS

FIG. 1 shows an exemplary configuration of an image processing system to which the present invention applied;

FIG. 2 shows an exemplary configuration of an operational panel of an image processing apparatus;

FIG. 3 is a block diagram showing the hardware configuration of a server device;

FIG. 4 is a block diagram showing the functional configuration realized by a CPU when user authentication is executed in the server device;

FIG. 5 is a block diagram showing the hardware configuration of an image processing apparatus;

FIG. 6 is a block diagram showing the functional configuration of a controller;

FIG. 7 is an example of a control of screen of a display unit executed by a display controlling part;

FIG. 8 is an example of an authentication guiding screen;

FIGS. 9A and 9B each shows an example of an initial operation screen;

FIG. 10 shows an example of a user operation screen;

FIG. 11 shows an example of the authentication guiding screen;

FIGS. 12A and 12B show examples of the initial operation screen and the user operation screen to designate a destination for fax transmission;

FIG. 13 conceptually shows a processing executed by the image processing apparatus and the server device;

FIG. 14 is a flow diagram explaining an exemplary process sequence executed by the controller of the image processing apparatus;

FIG. 15 is a flow diagram explaining the process sequence of an authentication successful processing in detail; and

FIG. 16 is a flow diagram explaining the process sequence of an authentication failure processing in detail.

### DESCRIPTION OF THE PREFERRED EMBODIMENTS

Preferred embodiment of the present invention is described in detail below with reference to figures. In the description given below, those elements which are shared in common among the preferred embodiments are represented by the same reference numerals, and these elements are not discussed repeatedly for the same description.

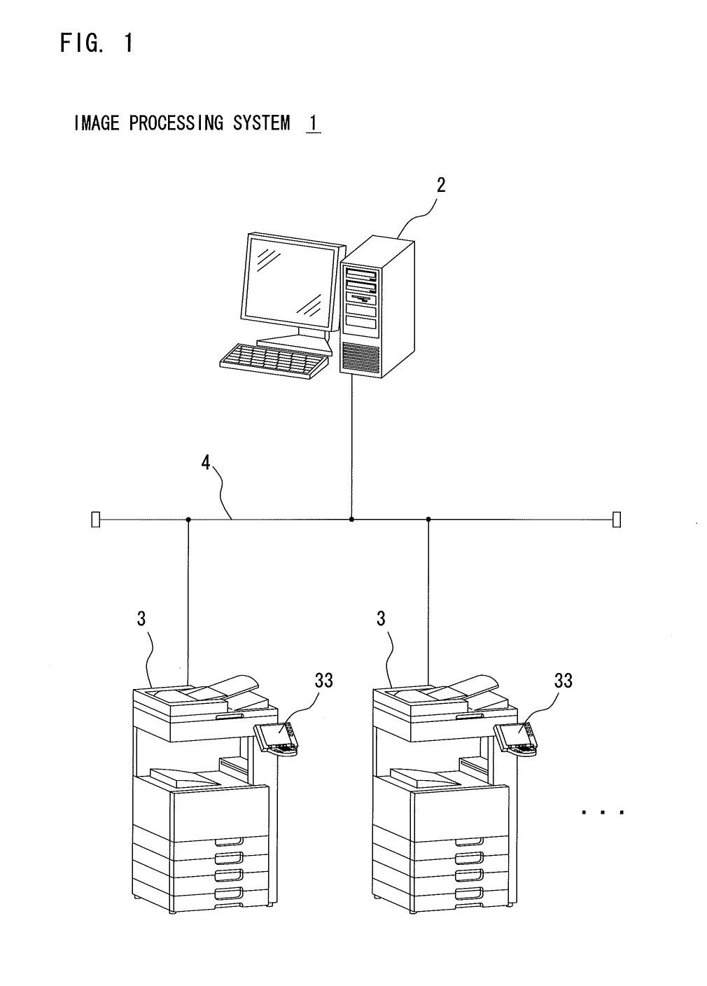

FIG. 1 shows an exemplary configuration of an image processing system 1 to which the present invention is applied. The image processing system 1 comprises a server device 2 and a plurality of image processing apparatuses 3 and 3 connected to each other through a network 4. Data communication between the server device 2 and the image processing apparatus 3 is enabled through the network 4. The network 4 is a network such as LAN (Local Area Network). In the example of FIG. 1, two image processing apparatuses 3 are connected to the network 4. The number of the connected image processing apparatuses 3, however, may be more than three or even one.

The image processing apparatus 3 is identified by name such as a digital complex device or an MFP having several functions such as a copy function, a scanner function, a fax function, a printer function, a box function (storage function). The image processing apparatus 3 includes an operation panel 33, set on the front side of its body, operable for a user to make entry.

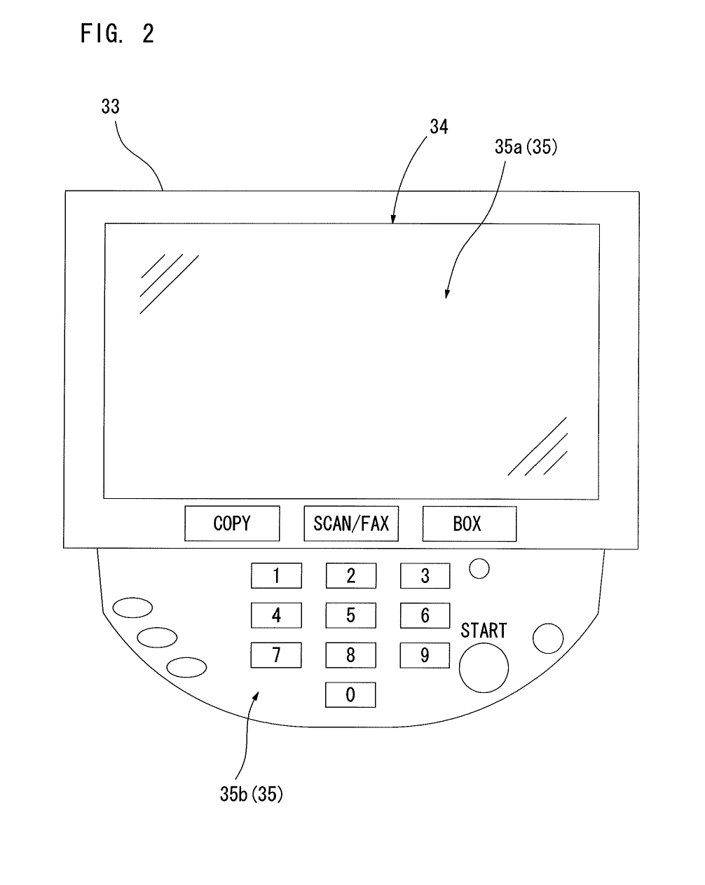

FIG. 2 shows an exemplary configuration of the operational panel 33 of the image processing apparatus 3. As illustrated in FIG. 2, the operational panel 33 has a display unit 34 on which various types of information is displayed to a user, and a manipulation unit 35 for the user to make an operation to entry. The display unit 34 is formed from a device such as a color liquid crystal display. The manipulation unit 35 is formed with a plurality of operation keys include both transparent touch panel keys arranged on the screen of the display unit 34 and push-button keys arranged around the display unit 34. The push-button keys include operation keys such as a key to select function with which the user selects a function to use from the copy function, the scanner function, the fax function, and the box function, a numerical keypad to make entry of numerical value and a start key to give instructions to execute a job to the image processing apparatus 3. In response to the operation to give instructions made by the user to the operational panel 33, a processing corresponding to the operation is executed in the image processing apparatus 3.

The image processing apparatus 3 of the preferred embodiment displays an authentication guiding screen on the display unit 34 at an initial state after it turned on, thereby alerting the user who uses the image processing apparatus 3 to make an operation for user authentication. The user makes entry of authentication information to identify the user with the authentication guiding screen being displayed. In the preferred embodiment, for instance, the user makes an operation to the operational panel 33, and user ID and password set in advance are entered as authentication information. The authentication information is not limited to the user ID and password. Card information is read from an IC card carried by the user, and the card information thereby read may be the authentication information, for example. Another, biometric information of the user such as a fingerprint or a vein pattern is read, and the biometric information thereby read may be the authentication information. In such a case, an IC card reader or a biometric information reader should be installed in the image processing apparatus 3 separately.

In response to the operation to make entry of the authentication information by the user, the image processing apparatus 3 transmits the authentication information thereby entered to the server device 2 through the network 4. To be more specific, with entry of the authentication information, the image processing apparatus 3 sends a request for authentication to the server device 2.

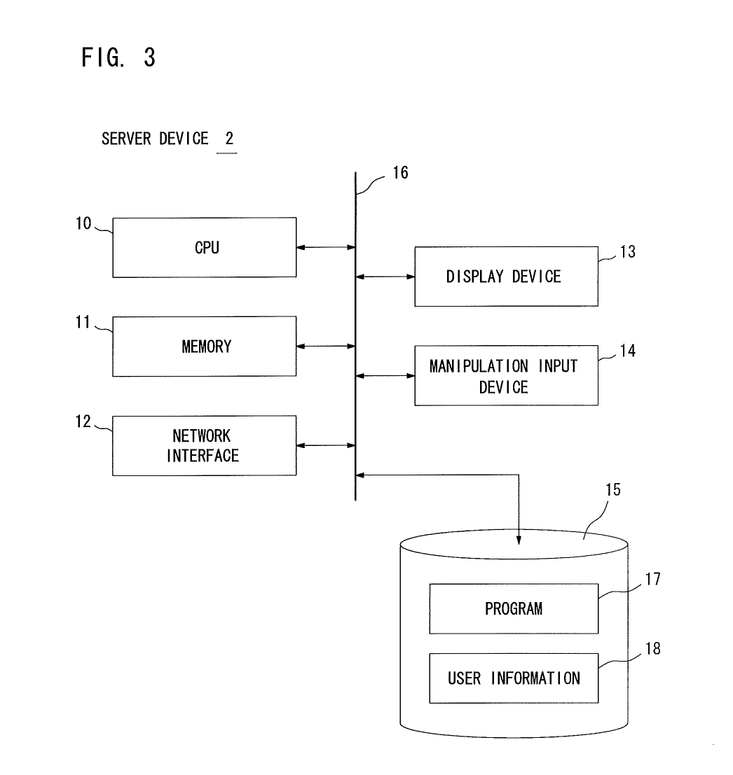

The server device 2 executes user authentication of all users who use each plurality of image processing apparatuses 3. FIG. 3 is a block diagram showing the hardware configuration of the server device 2. The server device 2 is formed from, for example, a computer generally used and includes a CPU 10, a memory 11, a network interface 12, a display device 13, a manipulation input device 14, and a storage device 15 connected through a data bus 16 in a manner that allows input and output of data therebetween.

The storage device 15 is formed from a storage device such as a hard disk drive. The storage device 15 stores therein a program 17, executed by the CPU 10, installed in advance. The storage device 15 also stores therein user information 18 in which information related to a user who is authorized to use the image processing apparatus 3 is registered.

The user information 18 registers therein a combination of a user ID and a password for each user and information related to authority of the respective user to use the image processing device 3. The information related to authority over use (hereafter, information related to use authority) indicates at least one function available for the user of multiple functions such as the copy function in the image processing device 3. The information related to use authority contains information to restrict the use as additional detailed restrictions placed when the user uses the available function. The information to restrict the use is for defining restrictions such as, for example, to restrict use of staple attached at execution of print output and/or upper limit of the number of printed sheets for each month.

The CPU 10 reads and executes the program 17 stored in the storage device 15, thereby executing user authentication of a user who uses the image processing apparatus 3. The memory 11 stores data therein such as temporary data required when the CPU 10 executes the program 17. The network interface 12 is responsible for connecting the server device 2 to the network 4. The display device 13 displays various types of information to users such as an administrator of the server device 2. The manipulation input device 14 receives the operation to make entry made by the users such as the administrator of the server device 2. By way of example, the administrator of the server device 2 refers to a display screen of the display device 13, and makes the operation of the manipulation input device 14. So, the administrator is allowed to register information related to the user who is authorized to use the image processing apparatus 3 for each user in the user information 18.

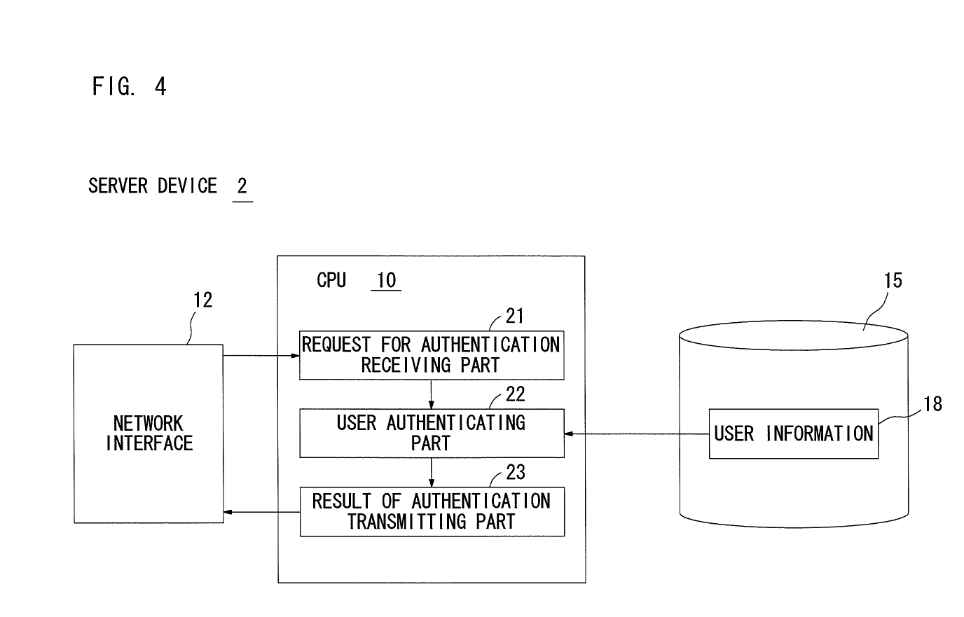

FIG. 4 is a block diagram showing the functional configuration realized by the CPU 10 when user authentication is executed in the server device 2. As illustrated in FIG. 4, the CPU 10 of the server device 2 executes the program 17, thereby becoming operative to function as a request for authentication receiving part 21, a user authenticating part 22 and a result of authentication transmitting part 23.

The request for authentication receiving part 21 receives the request for authentication from the image processing apparatus 3. The request for authentication receiving part 21 determines whether or not data received via the network interface 12 is the request for authentication from the image processing apparatus 3. If the received data is determined to be the request for authentication, the request for authentication receiving part 21 extracts the authentication information (combination of user ID and password) included in the request for authentication, and outputs to the user authenticating part 22.

In response to receipt of the authentication information from the request for authentication receiving part 21, the user authenticating part 22 reads the user information 18 stored in the storage device 15, and executes user authentication. The user authenticating part 22 determines, by matching one by one, whether or not a combination of user ID and password matches the authentication information received from the request for authentication receiving part 21 is registered in the user information 18. When the combination of user ID and password matches the authentication information received from the request for authentication receiving part 21 is registered in the user information 18, the user may be identified. So, the authentication results in success. In response to the authentication results in success, the user authenticating part 22 reads information related to use authority associated with the identified user, and registered. When the combination of user ID and password matches the authentication information received from the request for authentication receiving part 21 is not registered in the user information 18, the user may not be identified. So, the authentication results in failure.

After user authentication executed in the user authenticating part 22, the result of authentication transmitting part 23 obtains a result of authentication, and transmits the result of the authentication to the image processing apparatus 3 from which the request for authentication is transmitted. When the result of authentication executed by the user authenticating part 22 shows that the authentication results in success, the result of authentication transmitting part 23 transmits the result of authentication showing the authentication resulted in success and information related to use authority of the identified user to the image processing apparatus 3.

As described above, after receiving the request for authentication from the image processing apparatus 3, the server device 2 starts user authentication based on the authentication information included in the received request for authentication. As completing the user authentication, the server device 2 transmits the result of user authentication to the image processing apparatus 3.

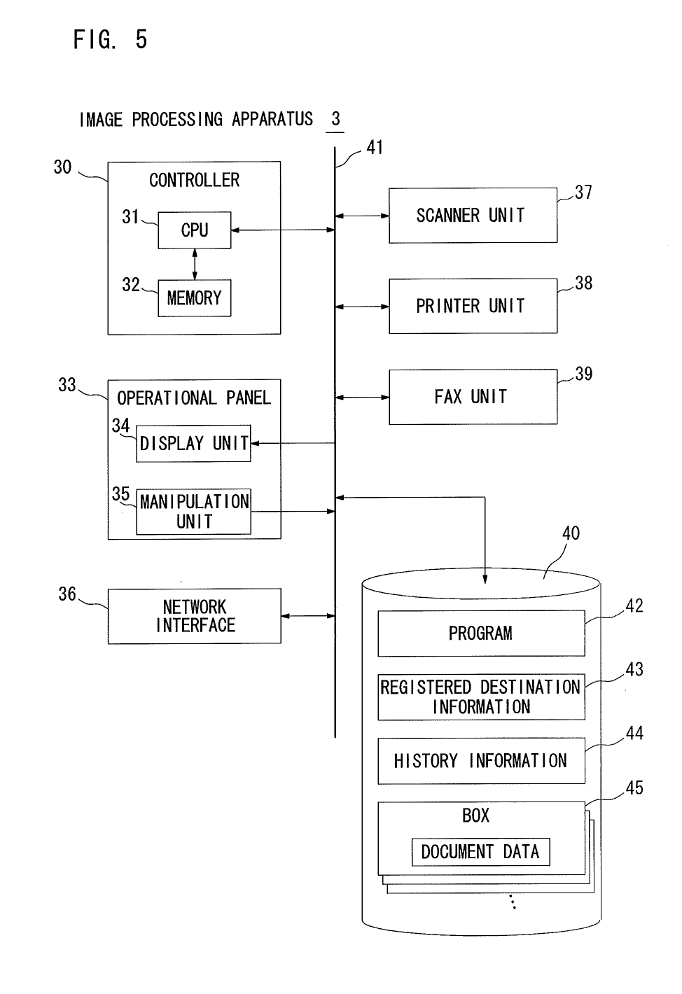

The detail of the image processing apparatus 3 is described next. FIG. 5 is a block diagram showing the hardware configuration of the image processing apparatus 3. The image processing apparatus 3 includes a controller 30, the operational panel 33, a network interface 36, a scanner unit 37, a printer unit 38, a fax unit 39, and a storage device 40 that are connected through a data bus 41 in a manner that allows data input and output with each other. The operational panel 33, a user interface of the user who uses the image processing apparatus 3, including the display unit 34 and the manipulation unit 35 as described above.

The controller 30, controls each part, including a CPU 31 and a memory 32. The CPU 31 reads and executes a program 42 stored in the storage device 40 when the image processing apparatus 3 is turned on. So, the CPU 31 becomes operable to function as a processing part of various types of processing as explained below. The memory 32 stores data therein such as temporary data required when the CPU 31 executes the program 42.

The network interface 36 is for connecting the information processing apparatus 3 to the network 4. The controller 30 performs data communication with the server device 2 via the network interface 36.

The scanner unit 37 reads a document optically, and performs photoelectric conversion, thereby generating image data. When, for example, the copy function, the scan function or the fax transmission function of the image processing apparatus 3 is used, the scanner 37 reads a document placed by the user. The scanner unit 37 then outputs image data.

The printer unit 38 forms an image on a printing medium such as a printing sheet based on the received image data, thereby executing print output. By way of example, when the copy function, the printer function or the fax transmission function of the image processing apparatus 3 is used, the printer unit 38 executes print output based on received image data.

The fax unit 39 transmits and receives fax data. In case of fax transmission, for example, the fax unit 39 generates fax data based on image data receives from the scanner unit 37. The fax unit 39 then transmits the generated fax data to a destination designated by the user. When receiving fax data, the fax unit 39 outputs the received fax data to the printer unit 38.

The storage device 40 is formed from a nonvolatile storage device such as a hard disk drive. The storage device 40 stores therein the program 42 installed in advance. The program 42 is executed by the CPU 31. The storage device 40 stores therein registered destination information 43 and history information 44.

The registered destination information 43 is information of destinations such as that for fax transmission or that for transmission of image data read with the scan function to another device (for example, another image processing apparatus 3 or another computer) connected to the network 4, registered in advance by the user. The history information 44 is information in which history of past use of the image processing apparatus 3 is stored. Information such as history of users who used image processing apparatus 3, history of jobs executed in the image processing apparatus 3 or history of destinations to which data is transmitted from the image processing apparatus 3 is stored in the history information 44.

The storage device 40 has at least one box 45 as a storage region in which data such as document data is stored. The box 45 is created for each user, for instance. Each user may store document data managed by himself in the box 45 allocated to him.

In the above-described configuration, the controller 30 controls a display screen displayed on the display unit 34 of the operational panel 33. With operation made by the user to the manipulation unit 35 of the operational panel 33, information is input. The controller 30 acquires the information thereby input, and executes various types of processing based on the acquired information.

In response to an entry of the authentication information, formed from the user ID and password, made by the user to the operational panel 33, the controller 30 starts authentication processing to authenticate the user based on the entered authentication information. In the authentication processing, the request for authentication including the entered authentication information is transmitted to the server device 2, and then the controller 30 is put into a waiting state until receiving the result of authentication from the server device 2. After receiving the result of authentication from the server device 2, the controller 30 determines the result of authentication. If the authentication results in success, the controller 30 effectively enables at least one function available for the user based on the information related to use authority of the user. At the same time, the controller 30 defines restrictions on use for each function based on the user's information to restrict the use.

In accordance with the start of the above-described authentication processing, the controller 30 starts a processing to receive a setting operation made by the user in parallel with the authentication processing. The setting operation made by the user includes an operation to set the detailed setting item of a function the user is using for execution of a job to a value desired by the user. As for instance, when the copy function is used, the setting operation may be an operation to make settings such as color setting for output, sheet setting and zoom setting. In response to the start of the authentication processing, the controller 30 displays the display screen operable for the user to make setting on the display unit 34 of the operational panel 33. The controller 30 then shows the display screen on which setting information entered with the operation made by the user to the manipulation unit 35 of the operational panel 33 is reflected. A function of the controller 30 is explained in detail next.

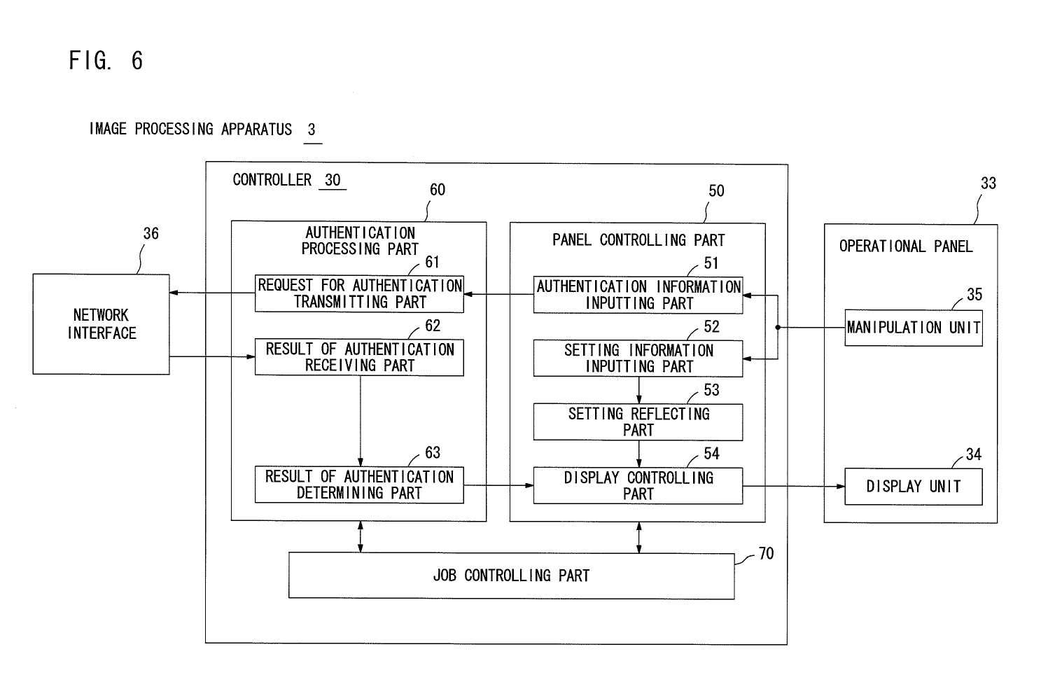

FIG. 6 is a block diagram showing the functional configuration of the controller 30. As the CPU 31 reads and executes the program 42, the controller 30 is put into operation to function as a panel controlling part 50, an authentication processing part 60, and a job controlling part 70. The panel controlling part 50 is responsible for controlling the operational panel 33. In response to the operation for instructions made by the user to the manipulation unit 35, the panel controlling part 50 acquires entered information from the manipulation unit 35, and executes various types of processing based on the entered information. In addition, the panel controlling part 50 controls the display screen displayed on the display unit 34 of the operational panel 33. The authentication processing part 60 executes authentication processing to authenticate the user. The authentication processing part 60 of the preferred embodiment sends the request for authentication to the server device 2, and receives the result of the user authentication from the server device 2. The authentication processing part 60 then refers to the result, and determines whether or not the authentication results in success. When an operation to a start key is made by the user and instructions for execution of a job are given, the job controlling part 70 controls execution of the job. The controller 30 puts the panel controlling part 50, the authentication processing part 60 and the job controlling part 70 into operation at the same time, thereby being capable of realizing the processing executed by those parts in parallel.

The panel controlling part 50 includes an authentication information inputting part 51, a setting information inputting part 52, a setting reflecting part 53, and a display controlling part 54. The authentication processing part 60 includes a request for authentication transmitting part 61, a result of authentication receiving part 62, and a result of authentication determining part 63.

The authentication information inputting part 51 processes the authentication information including a combination of user ID and password received from the manipulation unit 35 with the authentication guiding screen being displayed on the display unit 34. As receiving the authentication information from the manipulation unit 35, the authentication information inputting part 51 outputs the received authentication information to the request for authentication transmitting part 61 of the authentication processing part 60.

After receiving the authentication information from the authentication information inputting part 51, the request for authentication transmitting part 61 sends the request for authentication including the received authentication information to the server device 2 via the network interface 36. So, user authentication based on the authentication information may be executed in the server device 2. After the request for authentication transmitting part 61 sends the request for authentication, the result of authentication receiving part 62 of the authentication processing part 60 is put into operation. The result of authentication receiving part 62 is put into a waiting state until receiving a result of user authentication from the server device 2. When receiving the result of user authentication from the server device 2, the result of authentication receiving part 62 outputs the result to the result of authentication determining part 63. The result of authentication determining part 63 determines whether user authentication results in success or in failure, and outputs the result of authentication to the display controlling part 54 and the job controlling part 70. When the authentication results in success, the result of authentication determining part 63 outputs the information related to use authority of the user identified with the user authentication to the display controlling part 54.

The setting information inputting part 52 processes the setting information received from the manipulation unit 35 with the screen operable for the user to make settings being displayed on the display unit 34. More specifically, as receiving the setting information from the manipulation unit 35, the setting information inputting part 52 outputs the received setting information to the setting reflecting part 53. The start key included in the manipulation unit 35 is operated by the user with the screen operable for the user to make settings being displayed, and the instructions for execution of a job are given. The setting information inputting part 52 then processes the instructions for execution of the job. Therefore, in response to receipt of the instructions for execution of the job from the manipulation unit 35, the setting information inputting part 52 outputs the received instructions for execution of the job to the job controlling part 70.

The setting reflecting part 53 shows the display screen, displayed on the display unit 34, on which the setting information received from the setting information inputting part 52 is reflected by outputting the setting information to the display controlling part 54. The setting reflecting part 53 reflects the setting information received from the setting information inputting part 52 by outputting it to the job controlling part 70 when a job of each function is executed.

The display controlling part 54 controls the display screen displayed on the display unit 34. The display controlling part 54 controls the screen to be displayed on the display unit 34 corresponding to the status of user authentication executed by the authentication processing part 60. The control of screen is described in detail later.

The job controlling part 70 controls the scanner unit 37, the printer unit 38, the fax unit 39, the network interface or the storage device 40 based on the instructions for execution of the job, thereby controlling a sequence of operations accompanied with the execution of the job. By way of example, in case of instructions for execution of a copy job, the job controlling part 70 controls the scanner unit 37. The scanner unit 37 thereby controlled reads a document and acquires image data. The scanner unit 37 then outputs the image data to the printer unit 38. The job controlling part 70 controls the printer unit 38, thereby causing the printer unit 38 to execute operation of print output.

As described above, the job controlling part 70 receives the result of authentication executed by the authentication processing part 60. It is assumed that instructions for execution of a job are given without the result of authentication indicating the authentication resulting in success being obtained. Even in this case, the job controlling part 70 controls not to execute a part or a whole part of the sequence of operations required for the execution of the job. To be more specific, when the authentication has not been resulted in success, the job may not be fully executed. When the instructions for execution of the job are given with a result of authentication indicating the authentication resulting in success being obtained, the job controlling part 70 executes the whole of the sequence of operations required for the execution of the job. If a part of the sequence of operations required for the execution of the job has already been executed, the job controlling part 70 executes remaining operations when the result indicating that the authentication results in success is obtained.

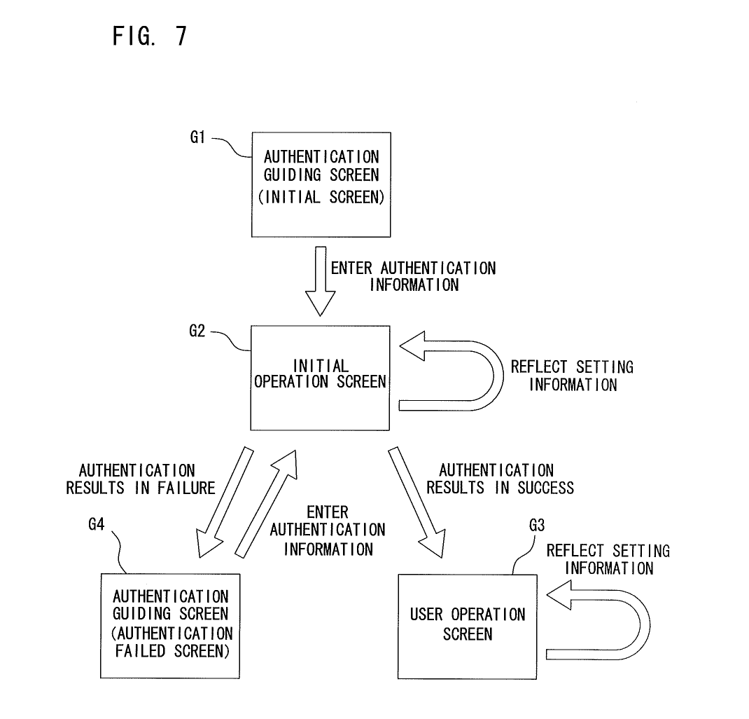

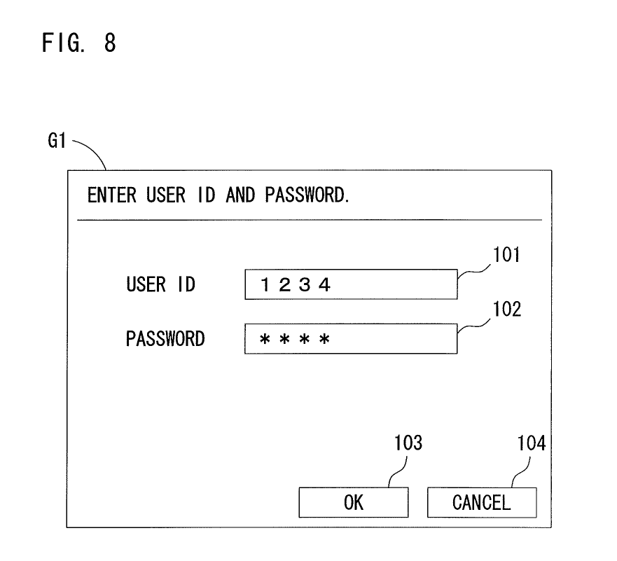

FIG. 7 is an example of the control of screen of the display unit 34 executed by the display controlling part 54. The display controlling part 54 displays an authentication guiding screen G1 as an initial screen on the display unit 34 in an initial state soon after the image processing apparatus 3 is turned on. FIG. 8 is an example of the authentication guiding screen G1. As illustrated in FIG. 8, a user ID entry field 101 to enter user ID, a password entry field 102 to enter password, an ok key 103 and a cancel key 104 are shown on the authentication guiding screen G1. The authentication guiding screen G1 is displayed on the display unit 34 to alert the user to make operation to enter the authentication information. The user makes operation to the manipulation unit 35 with the authentication guiding screen G1 being displayed. Thus, user ID and password may be entered as the authentication information. After the user makes operation of the ok key 103, the authentication information entered in the user ID entry field 101 and the password entry field 102 is output from the manipulation unit 35 to the authentication information inputting part 51. The cancel key 104 is operated to clear the authentication information entered in the user ID entry field 101 and the password entry field 102.

In response to the entry of the authentication information as described above, the authentication information inputting part 51 outputs the entered authentication information to the request for authentication transmitting part 61. The authentication processing part 60 then starts the authentication processing.

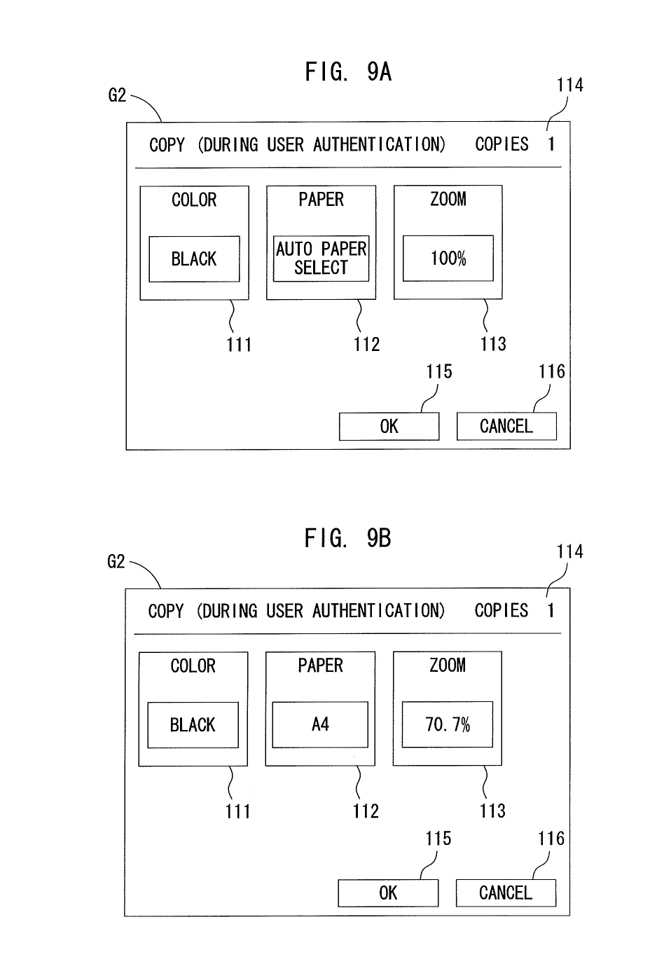

Returning to FIG. 7, in response to the start of the authentication processing by the authentication processing part 60, the display controlling part 54 displays an initial operation screen G2 operable for the user as a temporal logged-in state on the display unit 34. The initial operation screen G2 continues to be displayed until the authentication processing executed by the authentication processing part 60 completes. FIG. 9A and FIG. 9B each shows an example of initial operation screen G2. Each example shows the screen on which the user may make the operation to set variety of setting items as to copy function. As illustrated in each of FIGS. 9A and 9B, a massage indicating that the present status is during user authentication is shown on the initial operation screen G2.

FIG. 9A shows the initial operation screen G2 displayed on the display unit 34 soon after the image processing apparatus 3 transits to the temporal logged-in state. In the initial operation screen G2, “black” for a color setting item 111, “auto paper select” for a paper setting item 112, “100%” for a zoom setting item 113, and “one copy” for a copies setting item 114 are shown to be defined as default values. The user selects to operate respective setting item included in the initial operation screen G2, so that he or she may change the default value to a desired value. When setting operation to change the value is made by the user, the setting information based on the setting operation is received by the setting information inputting part 52 as described above. The setting reflecting part 53 then reflects the setting information on the initial operation screen G2 displayed on the display unit 34 by the display controlling part 54. So, the display controlling part 54 updates the contents to be displayed on the initial operation screen G2 based on the instructions given from the setting reflecting part 53.

FIG. 9B shows the initial operation screen G2 when the default values are changed to the desired values by the user. In FIG. 9B, the initial operation screen G2 shows the paper setting item 112 is changed to “A4” and the zoom setting item 113 is changed to “70.7%.” As an ok key 115 is operated by the user, the setting value of respective setting item is fixed. When a cancel key 116 is operated by the user, the setting value of respective setting item is returned to the default value.

To be more specific, as shown in FIG. 7, every time the setting operation is made by the user, the display controlling part 54 updates the contents of the initial operation screen G2 based on the setting information, and reflects the setting information to the initial operation screen G2. Accordingly, the user is able to make setting operation even until a result of authentication is obtained after the authentication processing is started by the authentication processing part 60. During the temporal logged-in state in which the initial operation screen G2 is being displayed, a part or a whole part of the sequence of operations required for the execution of the job is controlled not to be completed even when the instructions for execution of the job are given by the user by operating the start key. So, the execution of the job is limited. It is assumed, for example, the job is a copy job. In this case, an operation to read a document is executed by the scanner unit 37. The print output by the printer unit 38, however, is limited. Therefore, it enables to prevent the copy job to be fully executed even if the authentication results in failure.

With the initial operation screen G2 displayed as the temporal logged-in state, for example, the setting operation for every function of the image processing apparatus 3 may be made without limitation. In this case, all of the setting operations required for the execution of the job is allowed to be made by the user before the result of authentication is obtained by the authentication processing part 60. Under this circumstance, it is assumed setting exceeds his or her authority is made by the user. In such a case, the setting exceeds his or her authority is became disabled in the logged-in state which is after the authentication results in success. Also, with the initial operation screen G2, the setting operations only for minimum necessary functions to which all the users are given the use authority, for instance, may be made.

After receiving the result of user authentication from the server device 2, the authentication processing part 60 outputs the result of authentication to the display controlling part 54. In response to the receipt of the result of authentication from the authentication processing part 60, the display controlling part 54 changes the display screen of the display unit 34 corresponding to the result of authentication. As seen from FIG. 7, when the authentication results in success, the display controlling part 54 changes the display screen of the display unit 34 from the initial operation screen G2 to a user operation screen G3 in order to switch to the logged-in state in which the user is logging in. The display controlling part 54 shows the user operation screen G3 to which the function available for the user and the restriction on use defined for the user are reflected based on the information related to the use authority of the user identified with the user authentication.

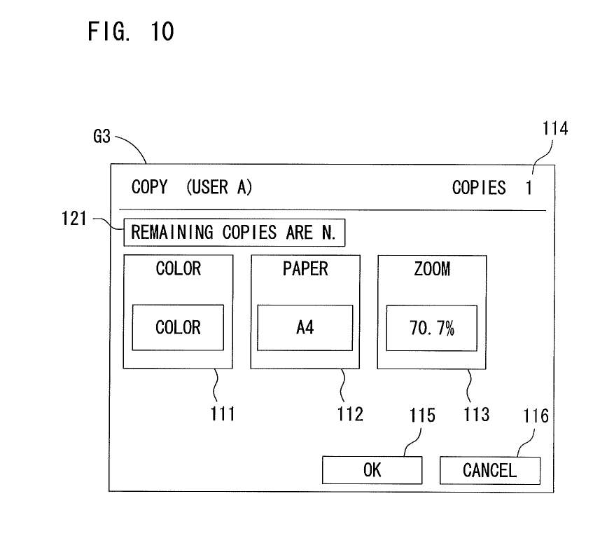

FIG. 10 shows an example of the user operation screen G3. In FIG. 10, user A is identified as a result of user authentication. The user operation screen G3 is displayed based on the information related to use authority corresponding to the user A. By way of example, the user operation screen G3 shows an available remaining copies display field 121 in which the number of copies remaining to the upper limit of the number of printed sheets defined in advance for the user A. Also, in the user operation screen G3, the setting information entered by the user with the initial operation screen G2 is displayed to be taken over as it is. As described above, for example, the initial operation screen G2 shows the paper setting item 112 changed to “A4” and the zoom setting item 113 changed to “70.7%.” In this case, it is assumed the user authentication results in success. The set values are then taken over after the display screen changed to the user operation screen G3.

The user operation screen G3 shows the default values defined in advance by the user for items that the user has not made the setting operation on the initial operation screen G2. It is assumed, for example, the user A defines “color” for the color setting item 111 as the default value as shown in FIG. 10. In this case, when the display screen is changed from the initial operation screen G2 to the user operation screen G3, “color” is set for the color setting item 111 on the user operation screen G3 and displayed. The default value is set only when the user A has not made the setting operation to change the color setting item 111 to the initial operation screen G2. As explained above, according to the preferred embodiment, the display controlling part 54 changes the display screen from the initial operation screen G2 to the user operation screen G3. At that time, if the setting operation to change is made by the user to the initial operation screen G2, the changed value is set in preference as the value of the respective setting item included in the user operation screen G3. If the setting operation to change is not made by the user to the initial operation screen G2, the default value defined in advance by the user for the respective setting item is set.

The setting operation is made by the user while the user operation screen G3 is being displayed as shown in FIG. 7. The display controlling part 54 then updates the contents of the user operation screen G3 based on the setting information, and reflects the setting information to the user operation screen G3. The user is authenticated successfully as the result of user authentication, and the image processing apparatus 3 transits to the logged-in state from the temporal logged-in state. Even in this case, the user is allowed to continue the setting operation made to the initial operation screen G2 to the user operation screen G3. When the start key is operated and the instructions for execution of the job are given by the user in the logged-in state in which the user operation screen G3 being displayed, the job is executed in accordance with the operation.

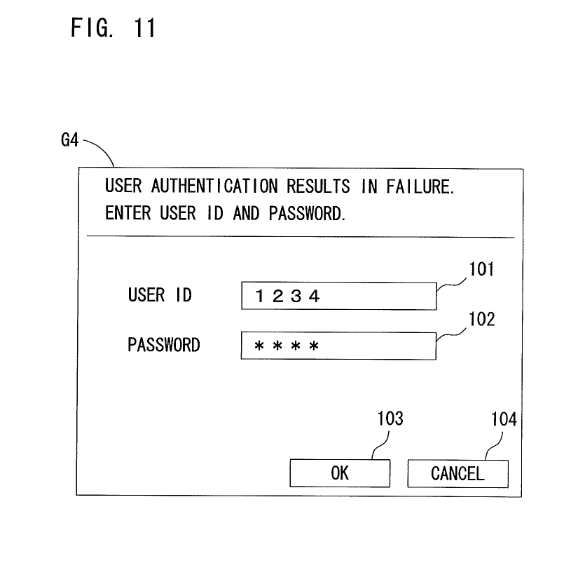

When the user authentication results in failure as shown in FIG. 7, the display controlling part 54 changes the display screen of the display unit 34 from the initial operation screen G2 to an authentication guiding screen G4 in order to receive entry of the authentication information again. FIG. 11 shows an example of the authentication guiding screen G4. The authentication guiding screen G4 notifies the user that the user authentication results in failure, different from the authentication guiding screen G1. As same as the authentication guiding screen G1 of FIG. 8, the user ID entry field 101 to enter user ID and the password entry field 102 to enter password are shown on the authentication guiding screen G4. The user makes operation of the manipulation unit 35 again with the authentication guiding screen G4 being displayed, thereby making entry of user ID and password as authentication information. As the ok key 103 is operated by the user, the authentication information inputting part 51 receives the authentication information entered to the user ID entry field 101 and the password entry field 102 from the manipulation unit 35. The authentication processing to authenticate the user again is then executed by the authentication processing part 60 again.

When the authentication results in failure and the display screen of the display unit 34 is changed from the initial operation screen G2 to the authentication guiding screen G4, the display controlling part 54 stores in the memory 32 the setting information which is reflected to the initial operation screen G2 at the time of change. After the display screen is changed from the initial operation screen G2 to the authentication guiding screen G4, the authentication information is entered by the user. The authentication processing is then executed again by the authentication processing part 60. After that, the display controlling part 54 changes the display screen of the display unit 34 again to the initial operation screen G2 from the authentication guiding screen G4. In the preferred embodiment, the display controlling part 54 reads the setting information stored in the memory 32, and reflects the read setting information to the initial operation screen G2. The initial operation screen G2 to which the authentication information is re-entered reflects the setting operation made by the user before the authentication results in failure. So, even when the user re-enters the authentication information because of the authentication resulted in failure, he or she may make setting operation to the initial operation screen G2 where he or she left off.

As explained above, the display controlling part 54 displays the four display screens, the authentication guiding screen G1, the initial operation screen G2, the user operation screen G3 and the authentication guiding screen G4 selectively on the display unit 34 corresponding to the status of the authentication processing executed by the authentication processing part 60.

The display controlling part 54 does not display secret information or data stored in the storage device 40 on the display unit 34 during the temporal logged-in state in which the initial operation screen G2 is being displayed. In the preferred embodiment, the storage device 40 stores therein the registered destination information 43 registered in advance by the user, the history information 44 related to usage history and document data stored in the box 45. The registered destination information 43, the history information 44 and the document data sometimes include secret information such as personal information or confidential information. It is assumed the user makes an operation to display the information during the temporal logged-in state in which the initial operation screen G2 is being displayed. Even in the case, the display controlling part 54 does not acquire the information stored in the storage device 40 or display the information. When changing the display screen to the user operation screen G3 in the logged-in state after the user authentication results in success, the display controlling part 54 acquires the information stored in the storage device 40, and displays on the display unit 34.

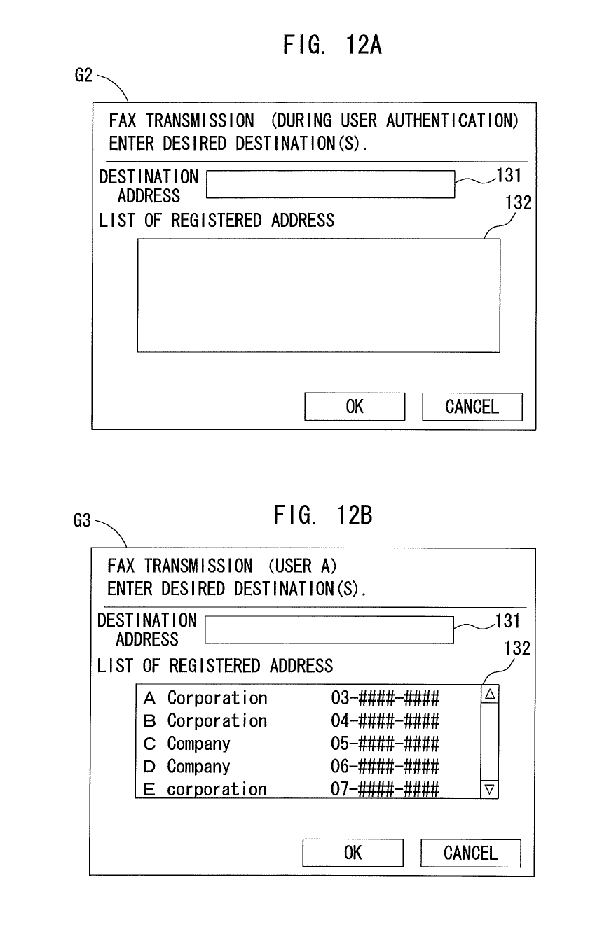

FIGS. 12A and 12B show examples of the initial operation screen G2 and the user operation screen G3 to designate a destination for fax transmission. This screen shows a destination address entry field 131 for the user to make entry of a destination by manual and a list of registered address field 132 to display at least one destination registered in the registered address information 43 in a list form. In FIG. 12A, the initial operation screen G2 does not display the destination registered in the registered address information 43 in a list form in the list of registered address field 132. The user is required to enter information such as the number of a destination to the destination address entry field 131 by manual. After the user authentication results in success, the display screen changes to the user operation screen G3 as shown in FIG. 12B. The destination registered in the registered address information 43 is displayed in a list form in the list of registered address field 132. The user is allowed to select a destination for fax transmission from the list. The user is also allowed to enter information such as the number of the destination to the destination address entry field 131 by manual with the user operation screen G3 being displayed.

In the preferred embodiment, the display screen is changed from the initial operation screen G2 in FIG. 12A to the user operation screen G3 in FIG. 12B. When a part of information such as the number of the destination is registered by the user to the destination address entry field 131 of the initial operation screen G2 by manual at the time of the change, the part of the entry is reflected to the user operation screen G3 and displayed. Also, in the preferred embodiment, the display controlling part 54 may make comparison between a character string, a part of it being entered, and a character string of the destination registered in the registered address information 43. The display controlling part 54 then extracts a destination including a character string close to the character string, a part of it being entered, automatically from the destination address registered in the registered address information 43. Therefore, the display controlling part 54 may display in preference the destination address automatically extracted in the list of registered address field 132. This results in greater improvement in operability.

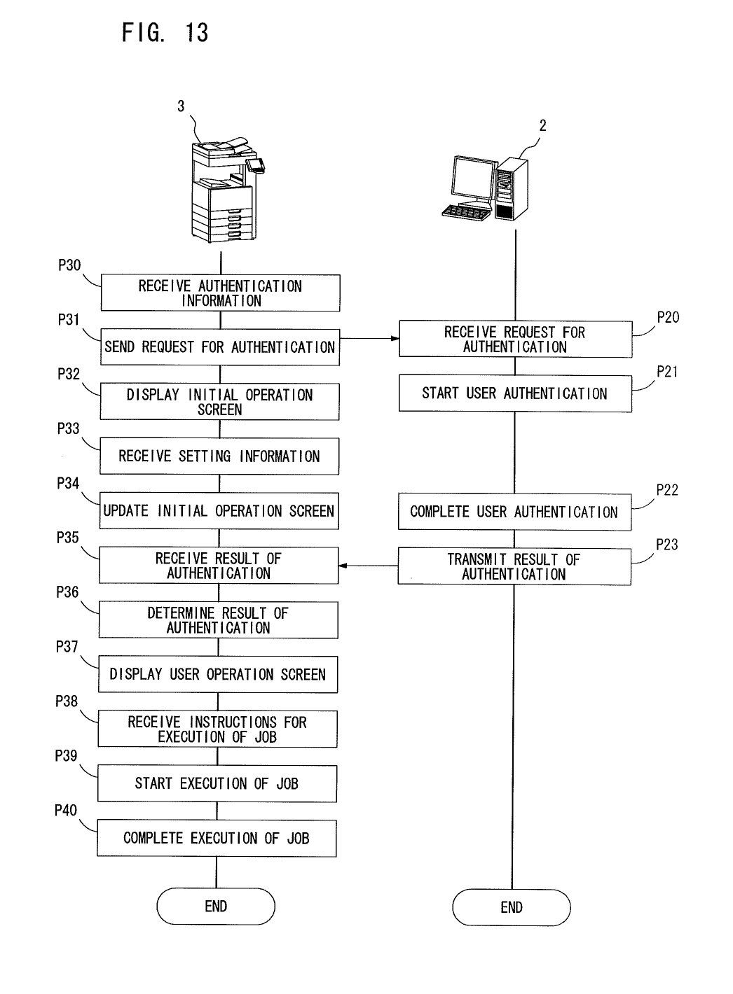

FIG. 13 conceptually shows the processing executed by the image processing apparatus 3 and the server device 2. FIG. 13 shows an example of the processing when the user authentication results in success. The image processing apparatus 3 displays the authentication guiding screen G1 on the display unit 34 at it turned on. As the authentication information is entered to the image processing apparatus 3 then (process P30), the request for authentication is sent to the server device 2 from the image processing apparatus 3 (process P31). In response to the receipt of the request for authentication from the image processing apparatus 3 (process P20), the server device 2 starts user authentication based on the authentication information included in the request for authentication (process P21).

After sending the request for authentication to the server device 2, the image processing apparatus 3 displays the initial operation screen G2 on the display unit 34 (process P32). The image processing apparatus 3 becomes capable of receiving the operation to set by the user, and receives the setting information based on the operation to set made by the user (process P33). The image processing apparatus 3 reflects the entered setting information to the initial operation screen G2, thereby updating the initial operation screen G2 (process P34). Processes P33 and P34 are executed repeatedly until the image processing apparatus 3 receives a result of the authentication from the server device 2. In the preferred embodiment, the above-described processes P32, P33 and P34 are executed in parallel with the user authentication executed in the server device 2.

When completing the user authentication based on the authentication information (process P22), the server device 2 transmits the result of the authentication to the image processing apparatus 3 (process P23).

After receiving the result of the user authentication from the server device 2 (process P35), the image processing apparatus 3 determines the result of the authentication (process P36). When the authentication results in success, the image processing apparatus 3 displays the user operation screen G3 on the display unit 34 (process P37). The image processing apparatus 3 is put into the logged-in state in which the user identified with the user authentication is logging in. As receiving the instructions for execution of the job given by the user (process P38), the image processing apparatus 3 starts execution of the job (process P39). In response to completion of the execution of the job (process P40), all processing completes. When an operation to log out is made by the user to the operational panel 33 during the logged-in state, the image processing apparatus 3 returns to the logged-in state, the initial state, and displays the authentication guiding screen G1 on the display unit 34.

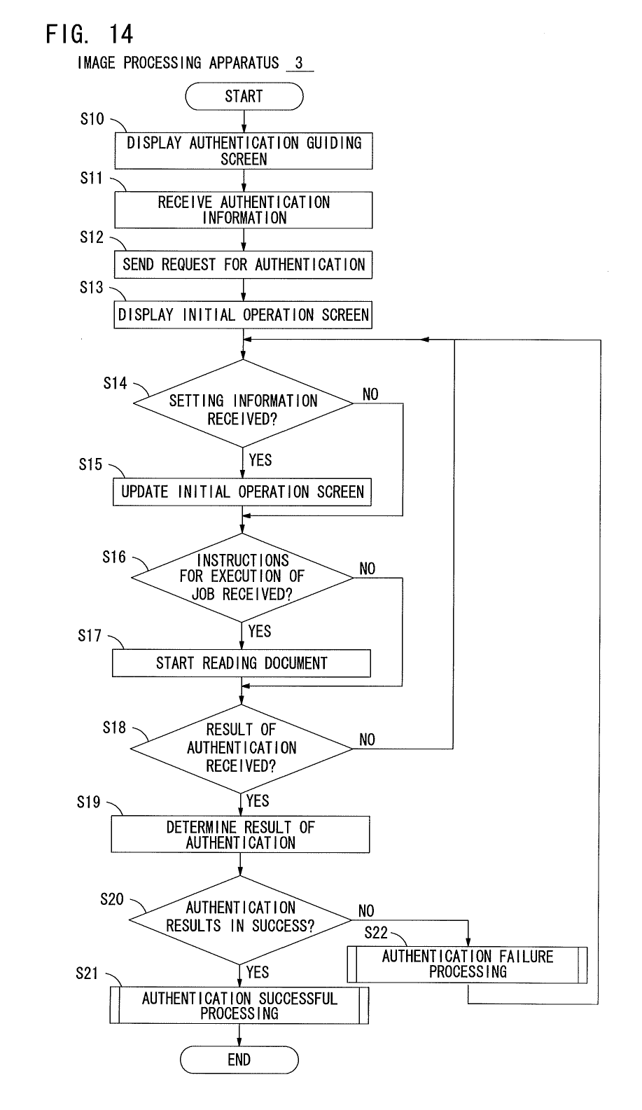

Next, the operation of the image processing apparatus 3 is described in detail. FIGS. 14 to 16 are flow diagrams explaining an exemplary process sequence executed by the controller 30 of the image processing apparatus 3. In the processing, a job specified by the user is, for example, a copy job, a scan job or a fax transmission job.

As shown in FIG. 14, as starting the processing, the controller 30 displays the authentication guiding screen G1 on the display unit 34 of the operational panel 33 (step S10). The controller 30 then receives entry of the authentication information (step S11). In response to the entry of the authentication information, the controller 30 sends the request for authentication to the server device 2 (step S12). So, the user authentication is started in the server device 2. After sending the request for authentication, the controller 30 transits the state of the image processing apparatus 3 from the log-out state to the temporal logged-in state. The controller 30 displays the initial operation screen G2 on the display unit 34, and causes the image processing apparatus 3 to receive the operation to set made by the user before obtaining a result of the user authentication (step S13). As explained above, the registered address information 43 and the history information 44 stored in the storage device 40 are not displayed on the initial operation screen G2. The document data stored in the box 45 of the storage device 40 is not displayed on the initial operation screen G2 either.

The controller 30 determines whether or not the entry of the setting information is made by the user with the initial operation screen G2 being displayed (step S14). When the setting information is entered (when a result of step S14 is YES), the controller 30 shows the initial operation screen G2 to which the setting information is reflected, thereby updating the initial operation screen G2 (step S15). The processing moves to step S16. When the setting information is not entered by the user (when a result of step S14 is NO), the controller 30 skips a processing in step S15 and moves to step S16.

The controller 30 next determines whether or not the instructions for execution of the job are given by the user (step S16). When the instructions for execution of the job are given (when a result of step S16 is YES), the controller 30 starts reading a document placed on the scanner unit 37 (step S17). The controller 30 stores image data generated from the read document in the memory 32 or the storage device 40. To be more detailed, any operation for the copy job, the scan job or the fax transmission job is not executed during the temporal logged-in state when the instructions for execution of the job are given. Only reading operation of the document is executed at the time. The processing then moves to step S18. When the instructions for execution of the job are not given (when a result of step S16 is NO), the controller 30 skips the processing in step S17 and moves to step S18.

The controller 30 determines whether or not it has received the result of the authentication from the server device 2 (step S18). When not receiving the result of the authentication from the server device 2 yet (when a result of step S18 is NO), the controller 30 returns to the processing in step S14 to execute repeatedly the processing to receive the operation to set made by the user and reflect to the initial operation screen G2. When receiving the result of authentication from the server device 2 (when a result of step S18 is YES), the controller 30 determines the result of the authentication (step S19) and determines whether or not the authentication results in success (step S20). If the authentication results in success (when a result of step S20 is YES), the controller 30 executes an authentication successful processing (step S21). If the authentication results in failure (when a result of step S20 is NO), the controller 30 executes an authentication failure processing (step S22).

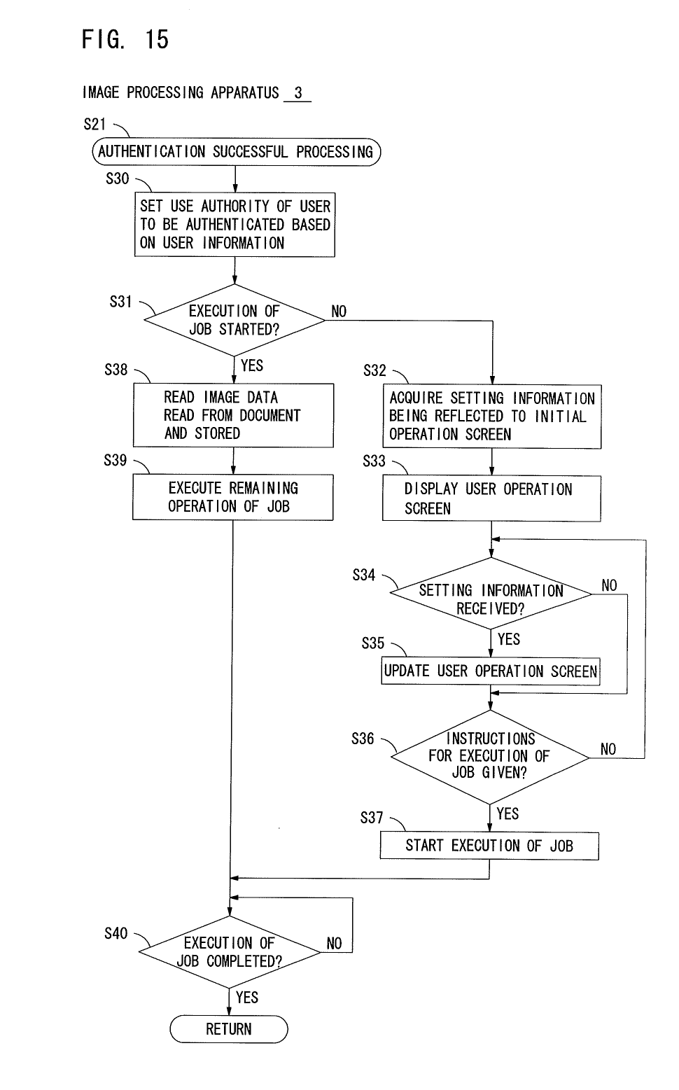

FIG. 15 is a flow diagram explaining the process sequence of the authentication successful processing (step S21) in detail. In case of the authentication resulted in success, the controller 30 has already acquired the user information (information related to use authority) of the user identified with the user authentication together with the result of authentication from the server device 2. In order to transit to the logged-in state in which the user identified with the user authentication is logging in, the controller 30 sets the use authority of the user based on the acquired user information (step S30). So, the image processing apparatus 3 is put into the logged-in state in which only function the user identified with the user authentication is authorized to use in advance becomes available.

The controller 30 then determines whether or not the execution of the job has already been started (step S31). When the execution of the job is not started yet (when a result of step S31 is NO), the controller 30 acquires the setting information being reflected to the initial operation screen G2 (step S32). The controller 30 shows the user operation screen G3 to which the setting information is reflected on the display unit 34 (step S33). The setting information to the initial operation screen G2 remaining to the user operation screen G3. The registered address information 43 and the history information 44 stored in the storage device 40 are allowed to be displayed then. Additionally, the document data stored in the box 45 of the storage device 40 is allowed to be displayed.

The controller 30 determines whether or not the operation to enter the setting information is made by the user with the user operation screen G3 being displayed (step S34). When the setting information is entered (when a result of step S34 is YES), the controller 30 reflects the entered setting information to the user operation screen G3, thereby updating the user operation screen G3 (step S35). The controller 30 then proceeds to step S36. When the setting information is not entered by the user (when a result of step S34 is NO), the controller 30 skips the processing in step S35 and proceeds to step S36.

The controller 30 determines whether or not the instructions for execution of the job are given by the user (step S36). When the instructions for execution of the job have not been given yet (when a result of step S36 is NO), the controller 30 returns to the processing in step S34 to execute the processing to receive the operation to set made by the user and reflect to the user operation screen G3. When the instructions for execution of the job have been given (when a result of step S36 is YES), the controller 30 starts execution of the job (step S37). At this time, the image processing apparatus 3 is in the logged-in state, so that the sequence of operations required for the execution of the job is executed in series without limitation.

When the execution of the job has already been started during the temporal logged-in state (when a result of step S31 is YES), the controller 30 reads the image data already stored in the memory 32 or the storage device 40 with transition to the logged-in state (step S38). The controller 30 then executes remaining operations of the job (step S39). Therefore, the remaining operations of the job specified during the temporal logged-in state are started. By way of example, print output of the copy job, transmission output of the scan job or fax transmission output of the fax transmission job is executed.

In response to the completion of the execution of the job started in step S37 or S39 (step S40), the processing completes.

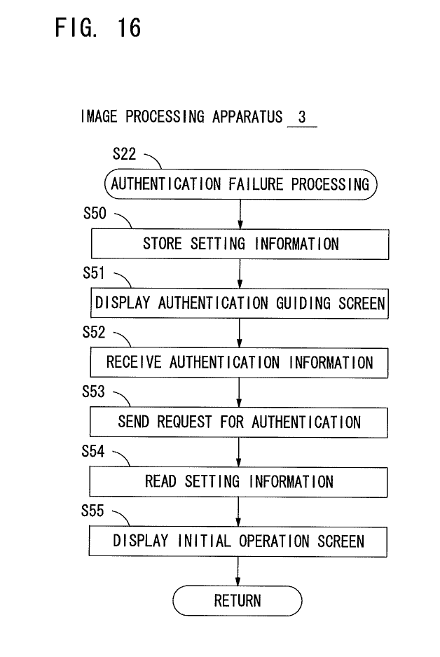

FIG. 16 is a flow diagram explaining the process sequence of the authentication failure processing (step S22) in detail. In case of the user authentication resulted in failure, the controller 30 stores the setting information being reflected to the initial operation screen G2 in the memory 32 (step S50). The controller 30 changes the display screen of the display unit 34 to the authentication guiding screen G4 from the initial operation screen G2 (step S51). In the preferred embodiment, the controller 30 indicates that the user authentication results in failure on the authentication guiding screen G4. The controller 30 receives re-entry of the authentication information (step S52). As receiving the authentication information, the controller 30 sends the request for authentication to the server device 2 (step S53). So, the user authentication is started in the server device 2 again. After sending the request for authentication, the controller 30 reads the setting information stored in the memory 32 (step S54), and displays the initial operation screen G2 to which the setting information is reflected on the display unit 34 again (step S55).

After the above-described authentication failure processing, the controller 30 returns to step S14 in FIG. 14 again and executes processing as explained above. So, the user is allowed to make operation to set where he or she left off in the previous operation to set.

The image processing apparatus 3 is caused to receive the operation to set made by the user with displaying the initial operation screen G2 until obtaining the result of the user authentication after entry of the authentication information by executing the above-described processing. As the operation to set is made by the user, the setting information accompanied with the operation is reflected to the initial operation screen G2. As a result, the user is allowed to start making operation to set for execution of a desired job rapidly after making operation to enter the authentication information. The user authentication completes, and the authentication results in success. The setting information entered to the initial operation screen G2 is then reflected to the user operation screen G3. So, the user is capable of making operation to set where he or she left off in the operation to set made to the initial operation screen G2 even after the image processing apparatus 3 transits to the logged-in state. The image processing apparatus 3 of the preferred embodiment is capable of reducing waiting time during which the user is not allowed to make any operation, so the efficiency in operation may be improved and convenience is enhanced.

It is assumed that the instructions for execution of the job are given by the user with the initial operation screen G2 as the temporal logged-in state being displayed. In this case, because of the above.₂described processing executed in the image processing apparatus 3, only a part of the sequence of operations required for the execution of the job is executed but not remaining job. After transiting to the logged-in state, the image processing apparatus 3 executes the remaining job. In response to the transition to the logged-in state, the execution of the job is completed rapidly. However, the execution of the job is not limited to this. The image processing apparatus 3 may not start the execution of the job in the temporal logged-in state even when the instructions for execution of the job are given.

As explained above, after the authentication information is entered by the user, the authentication processing to authenticate the user is started based on the entered authentication information. At the same time, the initial operation screen operable for the user to make setting is displayed in parallel with the authentication processing. The setting information entered by the user before a result of the authentication is obtained is reflected to the initial operation screen. Therefore, the user is capable of making operation to set rapidly after entering the authentication information, resulting in reduction of user's waiting time. As the result, convenience of the image processing apparatus is enhanced.

### (Modifications)

While the preferred embodiment of the present invention has been described above, the present invention is not limited to the preferred embodiment. Various modifications may be applied to the present invention.

In the preferred embodiment described above, for example, when the authentication information is entered to the image processing apparatus 3, the image processing apparatus 3 sends the request for authentication to the server device 2. So, user authentication is executed in the server device 2. However, the user authentication should not always be executed in the way. The user authentication based on the authentication information may be executed in the image processing apparatus 3.

What is claimed is:

1. An image processing apparatus, comprising:
a display part on which various types of information is displayed;
an authentication information inputting part for receiving entry of authentication information made by a user;
a setting information inputting part for receiving an operation to set made by the user, and inputting setting information;
an authentication processing part for starting authentication processing to execute user authentication based on said authentication information in response to the entry of said authentication information to said authentication information inputting part; and
a display controlling part for displaying an initial operation screen operable for the user to make setting on said display part in parallel with said authentication processing, and for reflecting said setting information received by said setting information inputting part to said initial operation screen before a result of said authentication processing is obtained and displaying.

2. The image processing apparatus according to claim 1, wherein
when said authentication processing executed by said authentication processing part results in success, said display controlling part changes a display screen of said display part from said initial operation screen to a user operation screen corresponding to an authority over use of the user authenticated with said authentication processing.

3. The image processing apparatus according to claim 2, wherein
when changing the display screen of said display part from said initial operation screen to said user operation screen, said display controlling part reflects said setting information reflected to said initial operation screen to said user operation screen.

4. The image processing apparatus according to claim 1, wherein
when said authentication processing executed by said authentication processing part results in failure, said display controlling part changes the display screen of said display part from said initial operation screen to an authentication guiding screen prompting the user to make operation to re-enter said authentication information with holding said setting information being reflected to said initial operation screen.

5. The image processing apparatus according to claim 1, further comprising:
a storage part for storing registered information registered in advance by the user or history information related to usage history, wherein
said display controlling part does not display said registered information or said history information with displaying said initial operation screen on said display part.

6. The image processing apparatus according to claim 1, wherein
said setting information inputting part further receives instructions for execution of a job given by the user,
said image processing apparatus further comprising:
a job controlling part for controlling a sequence of operations accompanied with execution of the job based on the instructions for execution of the job received by said setting information inputting part, wherein
said job controlling part controls not to execute a part or a whole part of said sequence of operations when the instructions for execution of the job is received by said setting information inputting part with said initial operation screen being displayed on said display part.

7. The image processing apparatus according to claim 1, further comprising:
a communicating part for making data communication with a server device executing user authentication, wherein
said authentication processing part transmits said authentication information received by said authentication information inputting part to said server device via said communicating part at start of said authentication processing.

8. An image processing system comprising a server device and an image processing apparatus being capable of making data communication with each other through a network,
said server device including:
a storage part for storing user information in which information related to multiple users is registered;
a receiving part for receiving authentication information transmitted from said image processing apparatus;
a user authenticating part for executing user authentication by matching said authentication information received by said receiving part and said user information stored in said storage part; and
a transmitting part for transmitting a result of the user authentication executed by said user authenticating part to said image processing apparatus, and
said image processing apparatus including:
a display part on which various types of information is displayed;
an authentication information inputting part for receiving entry of said authentication information made by the user;
a setting information inputting part for receiving an operation to set made by the user, and inputting setting information;
an authentication processing part for sending a request for user authentication to said server device by transmitting said authentication information received by said authentication information inputting part to said server device; and
a display controlling part for displaying an initial operation screen operable for the user to make setting on said display part at time of sending the request for user authentication to said server device, and for reflecting said setting information received by said setting information inputting part before receiving the result of user authentication from said server device to said initial operation screen and displaying.

9. The image processing system according to claim 8, wherein
when said user authentication executed by said server device results in success, said display controlling part changes a display screen of said display part from said initial operation screen to a user operation screen corresponding to an authority over use of the user authenticated by said server device.

10. The image processing system according to claim 9, wherein
when changing the display screen of said display part from said initial operation screen to said user operation screen, said display controlling part reflects said setting information reflected to said initial operation screen to said user operation screen.

11. The image processing system according to claim 8, wherein
when said user authentication executed by said server device results in failure, said display controlling part changes the display screen of said display part from said initial operation screen to an authentication guiding screen prompting the user to make operation to re-enter said authentication information with holding said setting information being reflected to said initial operation screen.

12. The image processing system according to claim 8,
said image processing apparatus further including:
a storage part for storing registered information registered in advance by the user or history information related to usage history, wherein
said display controlling part does not display said registered information or said history information with displaying said initial operation screen on said display part.

13. A display screen controlling method, comprising the steps of:
(a) displaying an authentication guiding screen prompting a user to make operation to enter authentication information on a predetermined display part;
(b) receiving the entry of said authentication information made by the user with said authentication guiding screen being displayed;
(c) starting authentication processing to execute user authentication based on said authentication information entered by the user; and
(d) displaying an initial operation screen operable for the user to make setting on said display part in response to start of said authentication processing, and reflecting said setting information entered by the user before obtaining a result of said authentication processing to said initial operation screen.
